(19) United States
(12) Patent Application Publication
(10) Pub. No.: US 2021/0272042 A1
(43) Pub. Date: Sep. 2, 2021

(54) METHOD FOR IMPROVING AN OPERATION PROCESS AND ARCHITECTURE

(71) Applicants: Timothy Dorsey, Weston, FL (US); Carla Dorsey, Weston, FL (US)

(72) Inventors: Timothy Dorsey, Weston, FL (US); Carla Dorsey, Weston, FL (US)

(21) Appl. No.: 17/188,839

(22) Filed: Mar. 1, 2021

Related U.S. Application Data
(60) Provisional application No. 62/984,057, filed on Mar. 2, 2020.

(51) Int. Cl. G06Q 10/06; G06T 11/20

(52) U.S. Cl. CPC G06Q 10/06393; G06Q 10/06316; G06T 11/206; G06Q 10/063114

(57) ABSTRACT

A method for monitoring and improving an operation; the operation consisting of one or more key processes, each key process having one or more activities. The method includes identifying at least one frustration associated with at least one key activity. Each frustration has an associated frustration type and frustration severity. At least one metric is identified and associated with at least one key activity. An improvement opportunity is determined as a function of at least two of the number of frustrations associated with a key activity, the severity of any one frustration associated with a key activity, and the number of metrics associated with any key activity. An improvement opportunity is assigned to each project, wherein a priority of projects is determined as a function of the criticality of the project.

### CROSS REFERENCE TO RELATED APPLICATIONS

This application claims the benefit of U.S. Provisional Application No. 62/984,057 filed on Mar. 2, 2020. The entire contents of this application is incorporated herein by reference in its entirety.

### BACKGROUND OF THE INVENTION

The present invention relates to a method for improving an operation process and architecture by analyzing the present operating state of an organization, and more particularly a method which utilizes process metrics, types of process frustrations and severity of process frustrations to determine an operation's strength and weaknesses and provide recommendation projects to alleviate the frustrations; improving the overall process performance.

Mapping the current state of an organization is known in the art. One example is the DMPM™ tool utilized by the Dorsey Group. This is an informational tool that visually represents the current state of an organization. It provides a stagnant snapshot of the operational state of the organization by identifying key processes, associated key activities, metrics and frustrations. However analysis utilizing the DMPM™ tool is dependent upon the knowledge and the experience of the reviewer. While it may accurately provide a snapshot of the past it does not update current situations as changes are made, nor does it provide corrective action. It is incapable of either mapping, tracking operation status, or providing recommendations in real time.

Accordingly, there is a need for a methodology for analyzing the present operating state of an organization which overcomes the shortcomings of the prior art.

### SUMMARY OF THE INVENTION

The overall operating state is made up of one or more key processes, each process having one or more key activities. Frustrations within the operating state are identified. A type and severity is assigned to a frustration. Metrics are also identified for one or more key activities. The frustration type and severity along with metrics are used to create a representation of a process as a function of each frustration with its associated type and severity and metrics associated with each key activity of the operation. An improvement opportunity is determined as a function of at least two of the type of frustrations, the severity of frustrations, and the number of metrics associated with a respective key process and/or a key activity. A project is assigned to each improvement opportunity and a priority of projects is determined as a function of the criticality of the project.

A process map is created and upon a project status change the process map is updated. A visual representation of the process map is made up of the key processes, the key activities, the frustrations, and metrics.

The associated frustration or metric may be no frustration or metric. However, anomalies may be determined by determining whether any particular key process or key activity is devoid of either a frustration or a metric. Anomalies are indicators of frustrations.

### BRIEF DESCRIPTION OF THE DRAWINGS

The features and advantages of the present invention will become more readily apparent from the following detailed description of the invention in which like elements are labeled similarly and in which:

FIG. 1A is a screenshot of a visual representation of the map constructed in which metrics and frustrations are indicated in accordance with the invention, but hidden;

FIG. 1B is a screenshot of a visual representation of the map constructed in which metrics and frustrations are shown associated with respective key activities in accordance with the invention;

FIG. 1C is a schematic diagram for determining frustration type and severity to create a base map in accordance with the invention;

FIG. 1D is a screenshot of a visual representation of the map constructed in accordance with the invention in which the frustration associated with a respective key activity is presented;

FIG. 2 is a flowchart for identifying improvement opportunities within a selected process in accordance with the invention;

FIG. 3 is a screenshot of a visual representation of type and severity of frustrations identified and presented in accordance with the invention;

FIG. 3A is a screenshot of a visual representation of identified metrics presented as a function of key process and key activity in accordance with the invention;

FIG. 3B is a screenshot of a visual representation of identified frustrations presented as a function of key process and key activity in accordance with the invention;

FIG. 4 is a flowchart for identifying improvement opportunities within the process in accordance with the invention;

FIG. 5 is a screenshot of a visual representation of a map constructed in accordance with the invention showing a key process and key activity when no associated metrics are identified;

FIG. 6 is a screenshot of a visual representation of a map constructed in accordance with the invention of a key process and key activity when no associated frustrations are identified with at least one key process;

FIG. 7A is a flowchart for transforming non critical improvement opportunities within the process to projects for addressing the opportunities in accordance with the invention;

FIG. 7B is a flowchart for transforming critical improvement opportunities within the process to projects for addressing the opportunities in accordance with the invention;

FIG. 8 is a screenshot of a visual representation of potential projects identified in accordance with the invention;

FIG. 9 is a screenshot of a visual representation of key process and key activity having cross linked frustrations in accordance with the invention;

FIG. 9A is a screenshot of a visual representation of key process and key activity having cross linked frustrations in accordance with the invention;

FIG. 10 is a flowchart for transforming potential projects into priority projects for management of the overall process in accordance with the invention; and

FIG. 11 is a block diagram of a system for performing the inventive method.

### DETAILED DESCRIPTION OF THE PREFERRED EMBODIMENTS

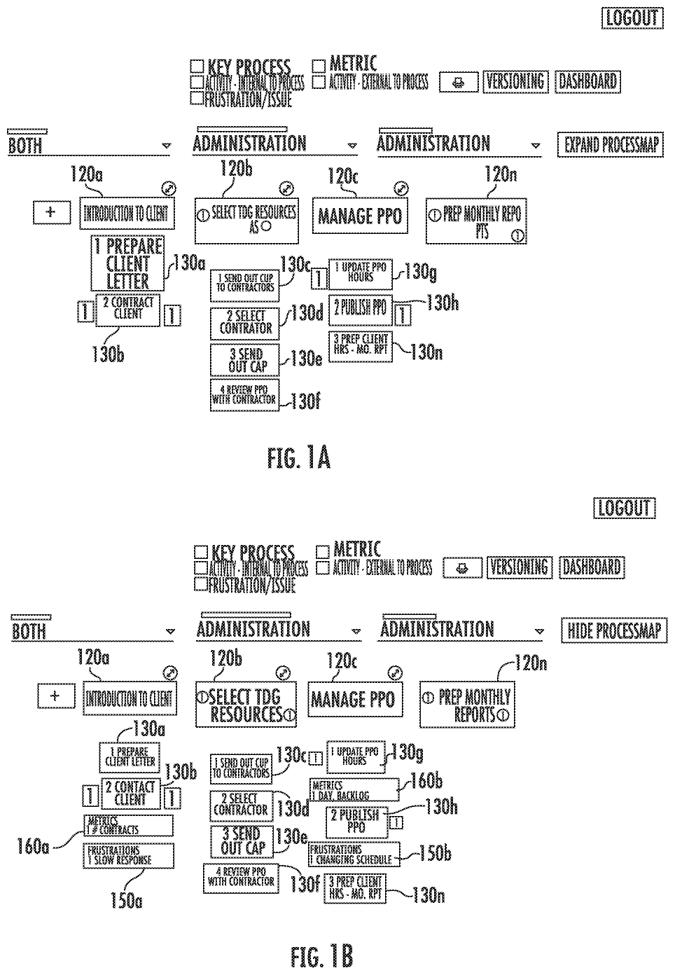

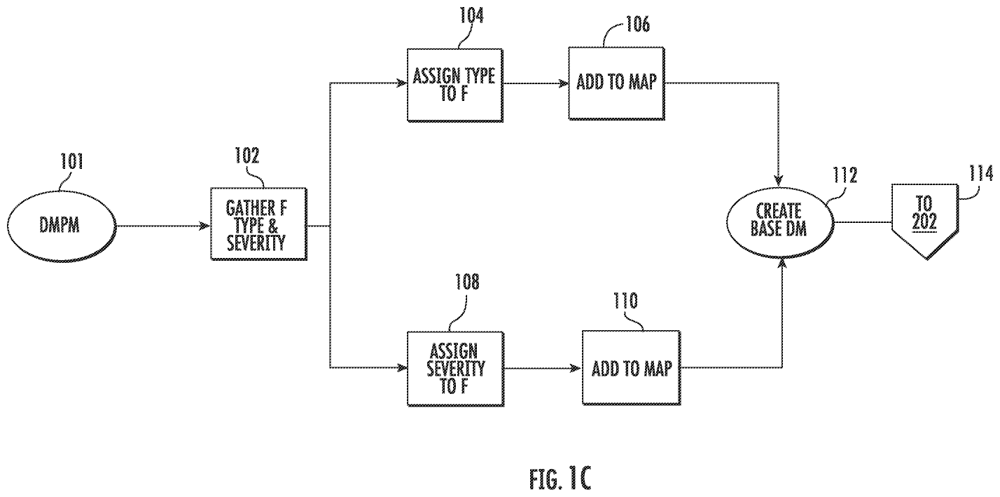

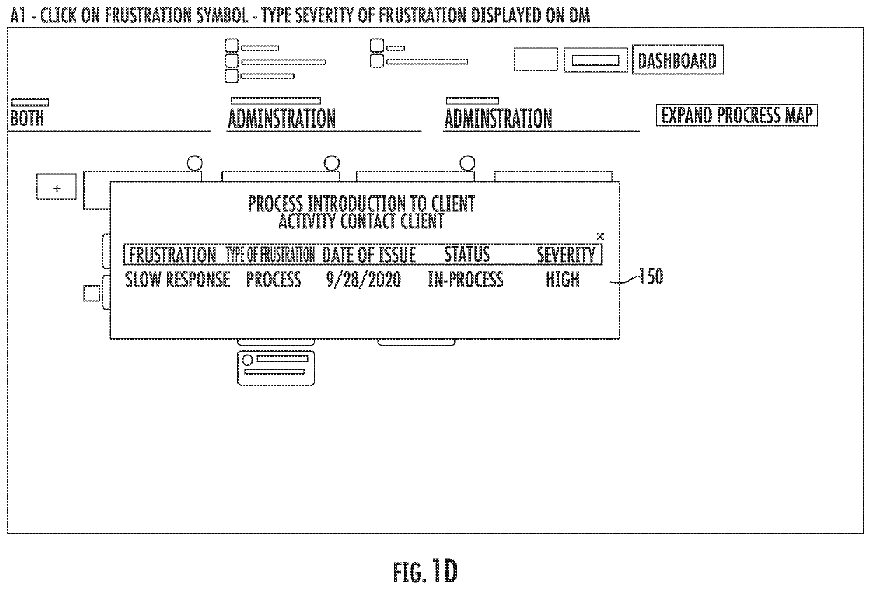

Reference is initially made to FIGS. 1A-1D in which first steps of the overall method for monitoring and improving an operation are shown. To map an overall operation as a function of key processes and key activities the key processes 120a-120n are logically arranged across rows as shown in FIG. 1A. A key process 120 can be almost anything performed by an organization in order to accomplish a goal such as an introduction to clients 120a, selecting resources 120b, manage the project plan for operation 120c, or prepare monthly reports 120n, by way of nonlimiting example.

Each key process may have one or more associated key activities 130a-130n to accomplish the process; shown in depending columns from each key process 120. By way of example, key process introduction to client 120a may include key activity steps such as prepare a client letter 130a and contact the client 130b. Similarly, key process 120b may include the steps of sending out Consultant Upcoming Work (“CUP”) reports to contractors 130c, key activity select contractor 130d, send out Consultant Awarded Work (CAP) reports 130e and/or review PPO with contractor 130e. Again, key process such as managing the Project Planner for Operations (“PPO”) 120c may include the steps of updated PPO hours 130f, publishing the PPO 130g and preparing client reports 130n.

Lastly it is known to populate the operation map with frustrations 150 and metrics 160; each of which may be associated with respective or the same key activity 130. Generally, frustrations 150 are activities, events or lack thereof which slow down or impede the optimal performance of a key activity 130. Frustration examples are a slow response from clients, a change in schedule to a key activity, a lack of forecasting, lack of inventory, lack of material, issues with receiving and processing orders, unscheduled equipment downtime or the like by way of nonlimiting example. Metrics 160 include data about a key activity 130 which indicate a status or condition about the key activity such as inventory total sales, total times key activity performed, build up, order backlog, number of contacts in a client or prospect list by way of nonlimiting example.

As can be seen from FIG. 1B the frustrations150 and metrics 160 may be visually represented as appearing adjacent the key activity 130 with which they are associated; facilitating ease of association when viewing the map in its visual embodiment. At other times, as seen in FIG. 1A the frustrations 150 and metrics 160 may appear as links which, when selected, expand into the indicators seen in FIG. 1B. In yet another embodiment it is known to provide different colors to key processes 120, key activates 130, frustrations 150 and metrics 160 to aid comprehension of the visual representation of the map. Selection of a frustration 150 utilizing a GUI will bring up information regarding frustration 150, such as the identity of the frustration (slow response), the type of frustration (process), the date of the issue (mm/dd/yyyy), the status (in-process), and even the severity (high), as seen in FIG. 1D.

Reference is now made to FIG. 1C in which the method for creating the inventive base map is provided. In a step 101 the prior art map, as discussed above, is created for the overall process to be operated upon. In a step 102 frustrations 150 are gathered. Frustrations 150 can be any factor associated with a key activity which interrupts or slows down the key process 120. In a step 104 a frustration type is assigned to the frustration 150 which is then added to the map in a step 106. In parallel therewith, in a step 108 a severity is assigned to each frustration 150. The severity is a scale having values assigned to the frustration 150 ranging in descending severity from critical, to high, to medium, to low by way of non limiting example. The severity of the frustration is added to the map in a step 110. In a step 112 a base map is created by adding frustration severity and frustration type to the base map of FIG. 1A and used as in input in step 114.

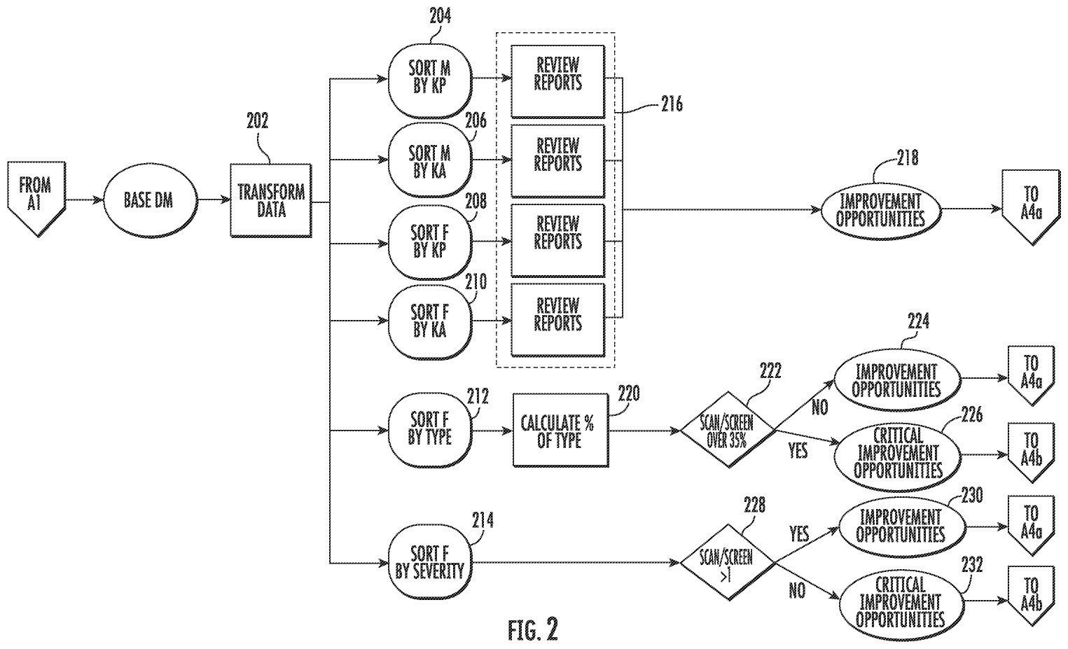

Reference is now made to FIG. 2 wherein the base map formed in step 112 is transformed, in a step 202, to determine opportunities for adjustment and correction of the process to alleviate frustrations. In step 202 the base map is analyzed. In step 202 opportunities may be determined as a function of an unexpected absence of metrics, unwanted or unexpected presence of metrics or some other anomaly. In a step 204 the map is sorted to determine the number of metrics 160 associated with each key process 120. In a step 216 the results of the respective sorting is analyzed. For example if any key process 120 is entirely absent of any metrics 150, this is an indicator of an issue because data should be associated with a process and an opportunity would be identified in step 216 and an exception flag indicating a potential situation for review and/or improvement is issued. As a result, quantitative analysis provides a qualitative indication.

Similar analysis is performed at a key activity level, in a step 206. As a result of the sorting, as determined in step 206, if there is less than one metric 160 for every predetermined number of key activities 130, four key activities by way of non limiting example, within any key process 120, an exception flag indicating a potential situation for review and/or improvement is issued.

On a parallel track, frustrations 150 are also sorted. In a step 208 frustrations 150 are sorted by associated key process 120. At the same time, frustrations 150 are sorted by key activity 130 in a step 210 and are analyzed in a step 216 to create frustration-based reports. Again, if any key activity 130 is absent of frustrations 150 this may be an indicator that frustrations 150 are not being tracked properly and a re-review of the process 120 is in order. In step 216 if it is determined that that there is more than one frustration 150, excess frustrations 150, for the associated key activity 130 then this would be an indicator that there is a bottleneck or a true operational breakdown of that key activity 130 so that as a response to steps 208 and 210 an exception flag or report regarding the lack of frustrations 150 or excess frustrations 150 is indicated in a step 216.

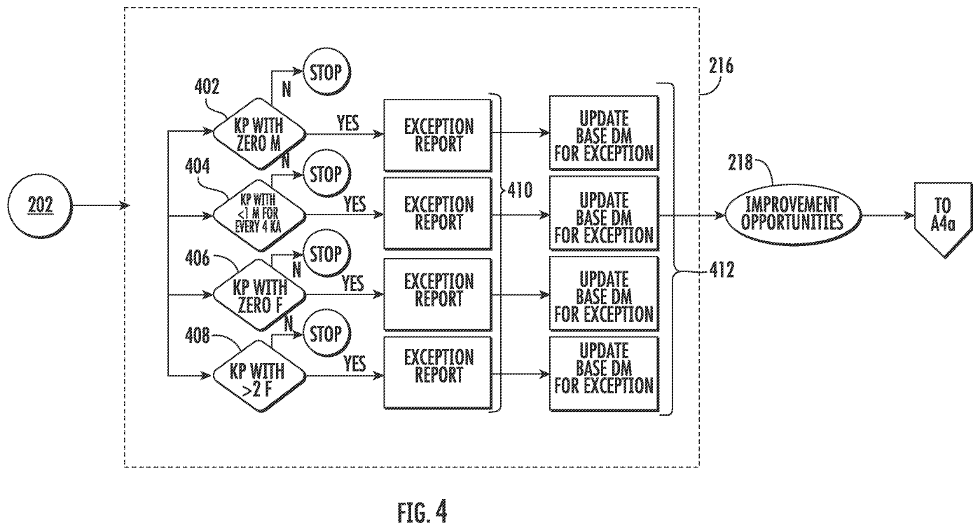

Reference is now made to FIG. 4 in which the reporting and flagging operation of step 216 is provided with greater particularity. As discussed above, in a step 202 the data from the base map is transformed and then sorted in steps 204-210. Once metrics are sorted by a respective key process 120, in a step 402, it is determined whether any key process 120 exist with zero associated metrics 160. If not, the analysis in step 402 stops. If yes, then in a step 410 an exception report/flag is generated and the base map is updated in a step 412 with an alert. In a step 218 the alert is processed to determine whether the alert corresponds to an improvement opportunity; by way of example if no metrics are associated with any one process 120 as determined by steps 204 and 216, this may be indicative of an opportunity to improve the process itself or the tracking of data associated with that process.

Similarly in a step 404 it is determined whether any key process 120 has less than one metric for every associated predetermined number of key activities 130; such as four key activities by way of nonlimiting example. Again, if the answer is no then the inquiry is stopped. If the answer is yes, then this too is indicative of the potential alert situation and an exception report is generated in step 410. The base map is updated for the exceptions with an alarm in step 412 and the key process 150 is identified for improvement opportunity in step 218.

As discussed above, frustrations 150 are even more indicative then metrics 160 of potential improvement opportunities. In a step 406 the data obtained in step 202 is analyzed to determine whether any key process 120 has zero associated frustrations 150. If not, then the process is stopped. However if any key process 120 has no associated frustrations 150, then an exception report is generated in a step 410 and the base map is updated with an associated alert in a step 412 and the system identifies the key process 120 as an improvement opportunity in a step 218.

In a step 408, the data from transformation 202 is analyzed to determine whether any key activity 130 has more than two frustrations 150 associated with it, regardless of severity. This is because multiple frustrations 150, even of lower severity, associated with a single key activity 130 may be an indicator of a disruption or bottleneck within the process 120, and in turn the overall operation. If there are one or less frustrations, the inquiry stops. If there are two or more frustrations 150 then an exception report is generated in step 410, the base map is updated for the exceptions with an associated alarm in step 412 and the key activity 130 is identified for improvement opportunity in step 218.

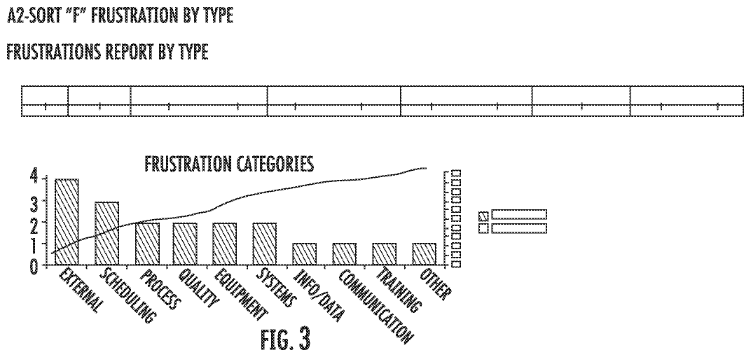

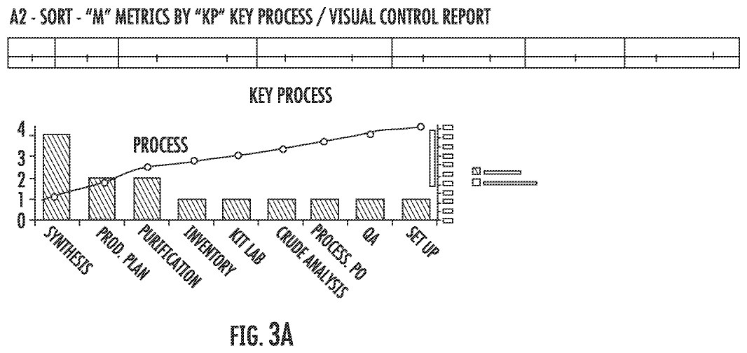

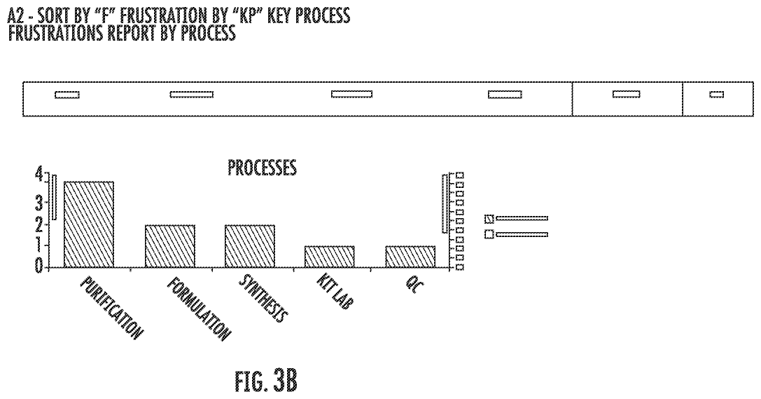

As a result of the analysis performed in step 216, the reports may be visually expressed as graphs of the sorting conducted in steps 204-210 as seen in FIGS. 3A and 3B. Utilizing the reports in step 218, improvement opportunities are identified for the identified key processes 120 and key activities 130.

Frustrations 150 when properly used can be an indicator of the criticality of the need for improvement. Returning to FIG. 2, in a step 212 frustrations 150 are sorted by type within the map in a step 220. The percentage of a particular frustration 150 as compared to the overall number of frustrations 150 is calculated to provide an indicator as to the most common frustrations 150. In a step 222 it is determined whether a particular type of frustration 150 represents more than a predetermined percentage of overall frustrations 150; 35% by way of nonlimiting example. If not, then the frustration 150 and associated key activity 130 is identified as a potential improvement opportunity in a step 224. However if the percentage is greater than a predetermined number then the system identifies that frustration type and associated key activity(ies) 130 as being a critical improvement opportunity in a step 226.

At the same time, frustrations 150 are sorted by severity in a step 214. The severity of a frustration 150 is an indicator of process criticality and need for improvement within the process 120. Each frustration 150 is analyzed to determine whether it exceeds a predetermined severity level; “critical” by way of nonlimiting example as compared to merely “high”. If it is determined in a step 228 that the frustration 150 is at least “critical” then the frustration 150 is identified as a critical improvement opportunity in a step 232. If the frustration 150 is less than critical it is still identified as an improvement opportunity in step 230, but not a critical improvement opportunity. The sorting of the frustrations may be visually represented as shown in FIG. 3.

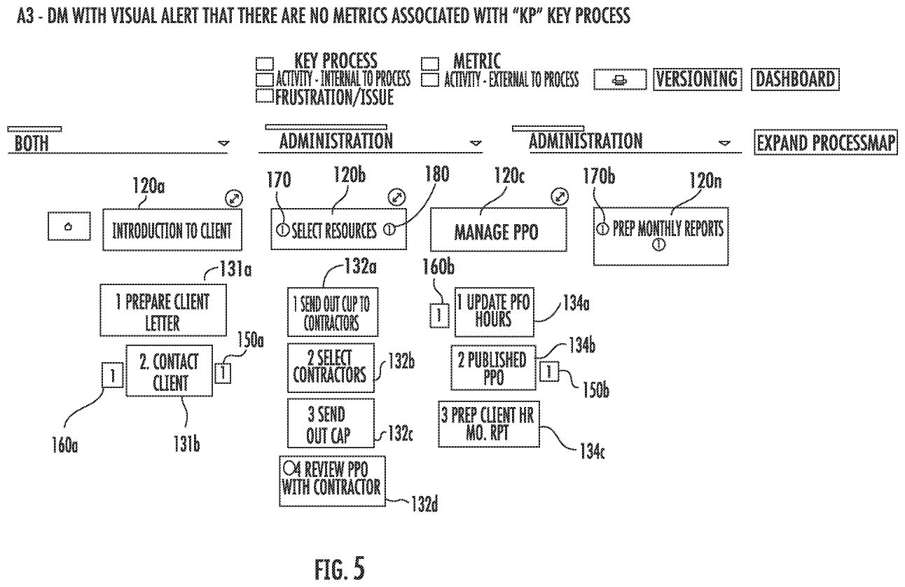

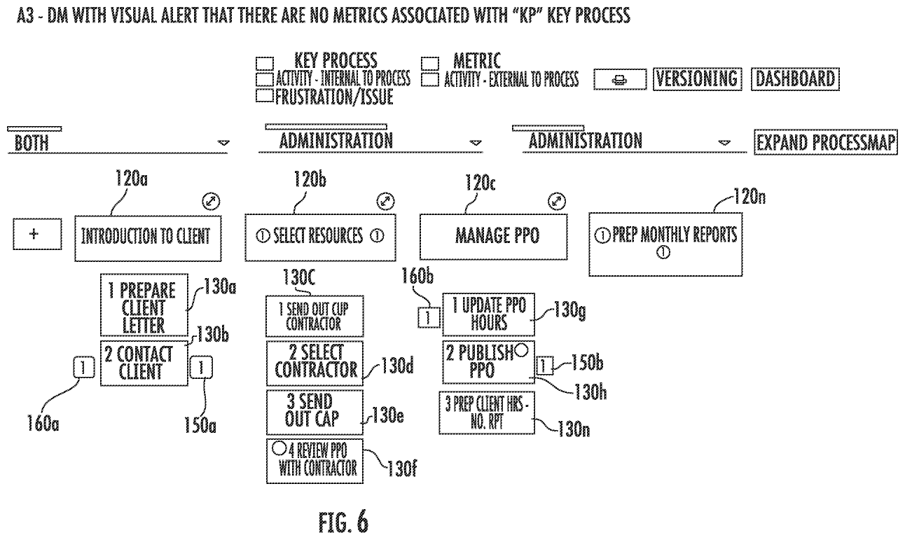

Reference is now made to FIGS. 5 and 6 in which a visual representation of the reports created in step 216 are provided. Like numbers are utilized for like structure. As can be seen in FIG. 6 key process 120b has no metrics 160 associated with any key activity 130 associated with the process 120b. As a result, an alarm 170a is provided at key process 120b to indicate the current state of key process 120b with respect to metrics 160. A similar alarm 170b is provided with key process 120n; prepare monthly reports which is also devoid of any associated metrics 160 (the alarm condition). In this way any user of the system is immediately, and easily, made aware that there are no metrics 160 associated with at least two key processes 120. This may not be an issue, as no metrics 150 may be required, but it acts as a check against a process 120 where metrics 160 are not properly input; an issue in and of itself.

Similarly, as seen in FIG. 5 where a key activity 130b has more than one frustration 150b associated therewith an alarm 180 may be provided as a visual indicator embedded within the visual indicator for key activity 130b. As an additional indicator, the respective tabs for metric 160 and frustration 150 may have a numerical indicator within the tab indicating the number of respective metrics and frustrations associated with that tab and in turn key activity 130 providing in additional visual indicator of the status and areas for potential improvement.

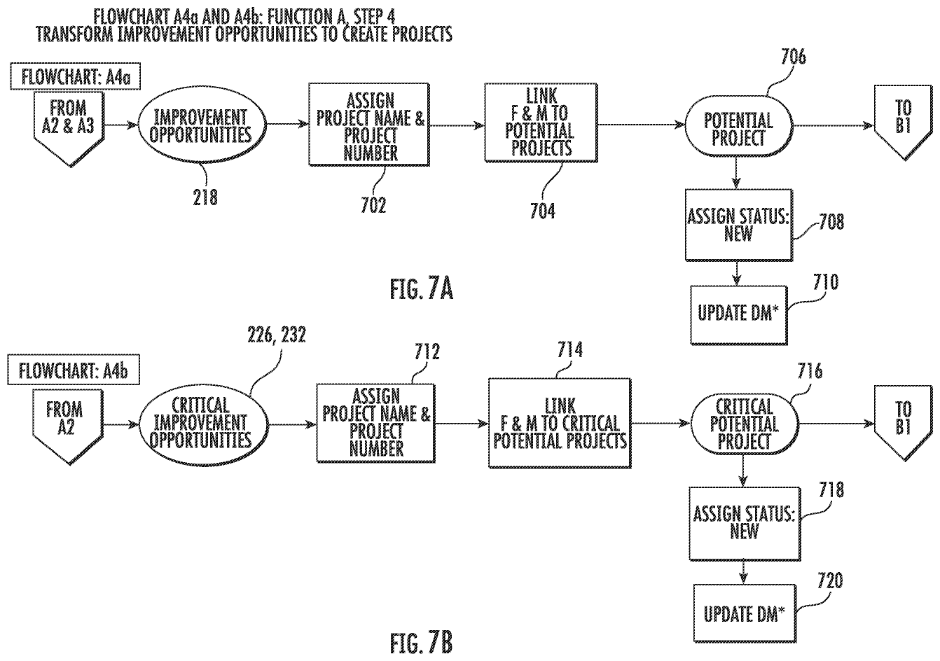

Once the frustrations 150 and metrics 160 have been utilized to determine potential improvements and the criticality thereof, improvement opportunities can then be transformed into data for creating projects. Reference is now made to FIGS. 7A and 7B in which the methodology for transforming both critical and noncritical improvement opportunities into specific projects is provided. As seen in FIG. 7B the critical improvement opportunities identified in steps 226, 232 are assigned project names and project numbers in a step 712. In a step 714 the frustrations 150 and metrics 160 associated with the respective projects are linked to create a critical potential project in a step 716. The newly created critical potential project is tagged as critical and both output to be transformed into a priority project and managed as will be discussed below and it is assigned a status in a step 718. Because it is a new project it is assigned a new status and the map is updated in a step 720.

In step 702 project names and numbers are assigned by any known predetermined method such as sequentially, in order of processing, etc. in step 702. Names may be arbitrarily assigned as a function of the opportunity to be improved, the key process affected, or the like. Furthermore, as shown in FIGS. 3A and 3B, the inventive methodology sorts the frustrations by types (categories) as well as by mapping the severity of a frustration to a process and key activity (FIG. 3). As seen in FIG. 3A metrics are also mapped as a function of key process as well as key activity. This sorting enables the linking of frustrations and metrics to potential projects in step 704.

Similarly, as seen in FIG. 7A the non-critical improvement opportunities identified in step 218, as a function of frustration type and severity, are assigned project names and project numbers in a step 702. In a step 704 the frustrations 150 and metrics 160 associated with the respective projects are linked to create a non-critical potential project in a step 706. The newly created potential project is tagged as non-critical and both output to be transformed into a project and managed as will be discussed below and it is assigned a status in a step 708. Because it is a new project it is assigned a new status and the map is updated in a step 710.

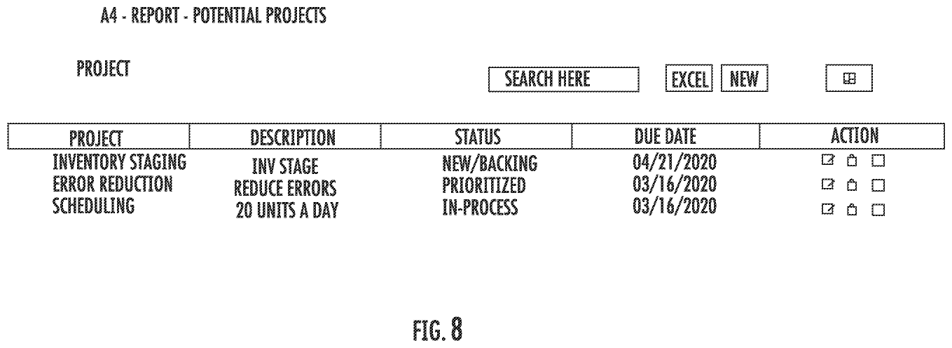

Utilizing the data generated from the methodology of FIG. 7A and FIG. 7B a potential projects report (FIG. 8) may be generated. Examples of projects are inventory staging, error reduction and scheduling. Similarly, a report of frustrations linked to potential projects may also be generated as shown in FIG. 8.

The methodology enables the system to operate in a continual loop for monitoring operational performance. Utilizing the potential projects created above as a function of type and severity of frustration, the potential projects may be prioritized to create priority projects. These priority projects can be tracked and the status updated in a real time basis. Once a priority project is complete, it may be archived and replaced with a new priority project ranked in order as to criticality. The map becomes a living document and reported in real time as changes are made.

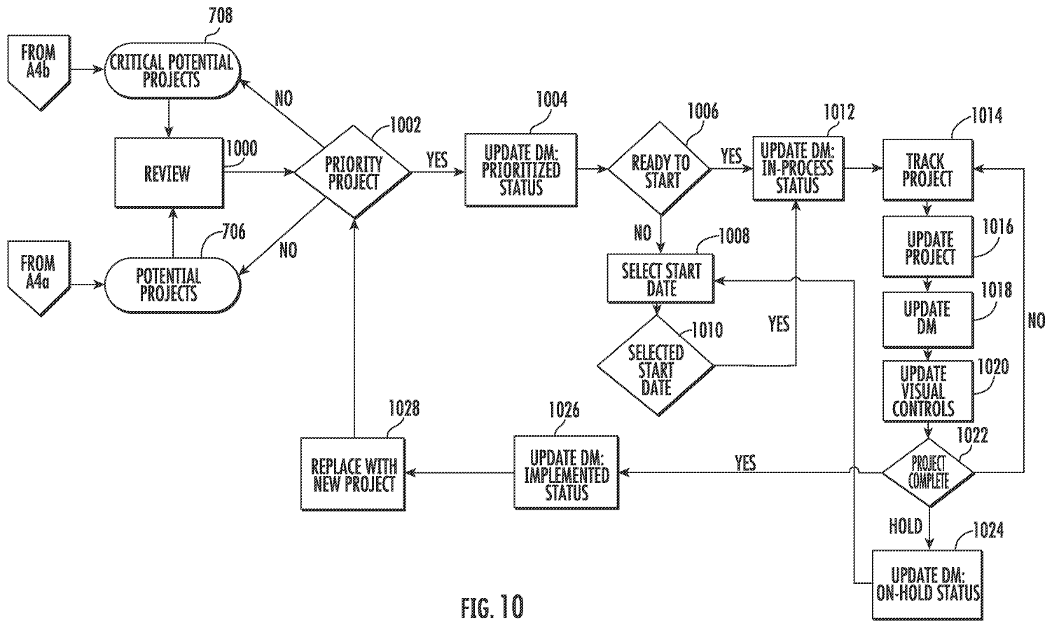

Reference is now made more specifically to FIG. 10 in which the process for transforming potential projects into priority projects while tracking and managing updates based upon the priority project status is provided. As discussed above, in step 708 critical potential projects have been identified while at the same time noncritical potential projects have been identified in step 706. Both critical potential projects and non-potential projects are reviewed in a step 1000 to rank the projects by priority and create a prioritized list of potential projects.

In step 1002 the reviewed projects are again reviewed to determine whether the project is a priority project. If it is determined to be a critical nonpriority potential project the process returns to step 708. If it is determined to be a nonpriority noncritical potential project the process is returned to step 706. If it is determined to be a priority project, then the map is updated in a step 1004 to reflect the prioritized status of the project and begin the fulfillment of the project. As a result, the most important and timely projects become enabled ahead of the less critical.

In a step 1006 it is determined whether a project is ready to start. If yes, then the project status is updated to “in process” on the map in a step 1012. If not, because of a lack of resources or manpower by way of nonlimitng examples, then in a step 1008 a different start date is selected. If the current date is the start date, as determined in a step 1010 then the project is started and the status of the process is updated in the map to recognize the project has started in a step 1012. If the current start date is not the start date, then the process is repeated until the start date coincides with the current date.

The project is tracked in a step 1014. As progress is made the project is updated in a step 1016 and the map is updated in a step 1018. As the map is updated the visual version thereof is updated in a step 1020. In a step 1022 it is determined whether the project has been completed. If not, the process returns to the tracking step of step 1014 so that a loop is formed to monitor and update the status of any project until completed. If a project is on hold as determined in step 1022 then the map is updated to indicate the hold status in step 1024 and it is determined whether today is the re-start date in step 1010 until the project is restarted. If the project is complete then the map is updated in a step 1026 to indicate implementation of the project.

If the project is completed, it is replaced with a new project and the process begins again at step 1002 in which the high as prioritized project is selected.

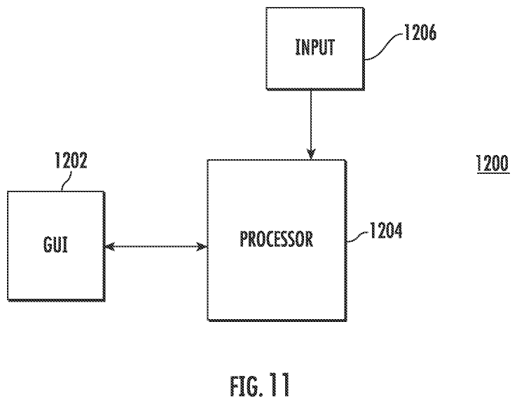

Reference is now made to FIG. 11 in which a system, generally indicated as 1200 for performing the method described above is provided. System 1200 includes a processor 1204 for performing the transformative steps on the input frustration information and metrics as described above. The true benefit of the invention is the ability to provide a dynamic visual version of the operation map which may be manipulated and updated in real time. Therefore a graphic user interface (“GUI”) 1202 is provided in communication with processor 1204 to both input information to processor 1204 and 2 display a map created by processor 1204. While it is preferable to utilize graphical inputs and outputs, it is readily understood that the process can be performed without visual inputs and therefore, an electronic input 1206 for providing data to processor 1204 is also provided.

In accordance with the process, an operation of interest is selected. It is determined which are the key processes 120 for performing the overall operation. The key processes 120 are input to processor 1204. It is also determined which are the key activities 130 associated with each key process 120. Processor 1204 determines the relationship between a key activity 130 and the key process 120 and stores that association. In accordance with the invention once the key processes 120 and key activities 130 are determined, frustrations 150, frustration type, frustration severity and metrics 160 are input to processor 1204 which associates the appropriate frustration 150 and metrics 160 with the proper key activity 130.

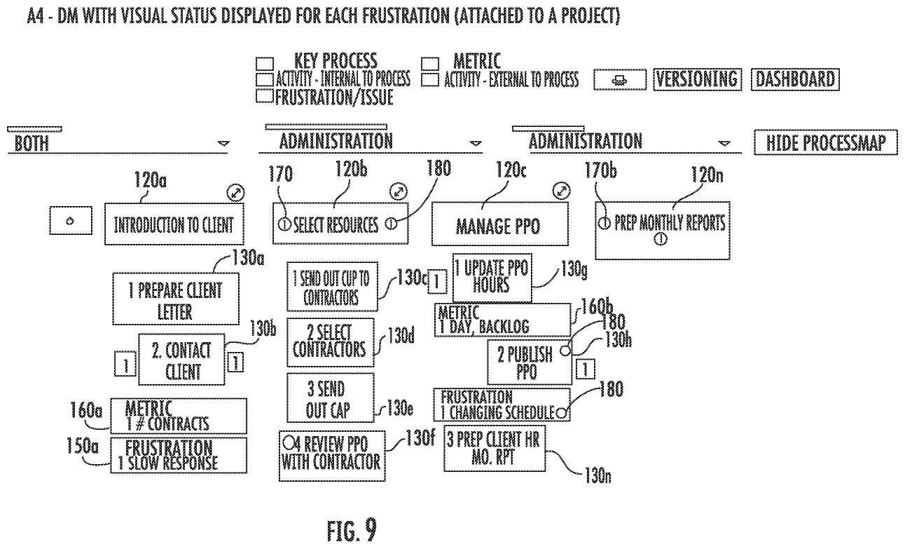

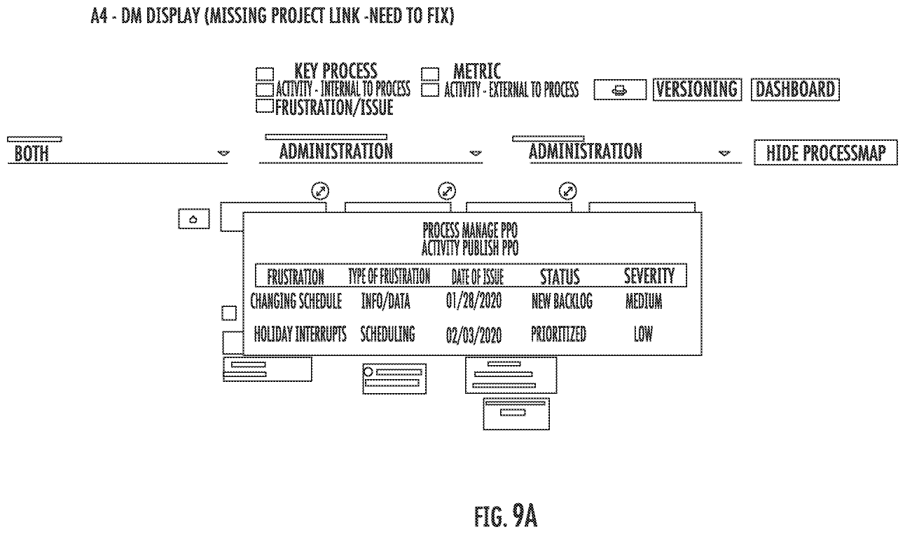

In a preferred nonlimiting embodiment of these associations are displayed at GUI 1202 as a map such as that shown in FIG. 9 it should be noted that in a preferred embodiment, processor 1204 may cause a map of key processes 120 and key activities 130 to be displayed as a map at GUI 1202, where frustrations 150 and metrics 160 can be input by associating frustrations 150 and metrics160 with key activities to be processed by processor 1204.

Processor 1204 operates on the input frustrations 150 and frustration properties, and metrics 160 as discussed above to transform this input information into improvement opportunities 218 the improvement opportunities 218 are converted to potential projects and ranked in order of priority as a function of the frustration and metric information to be operated upon and expressed as an updated map at GUI 1202.

Additionally alerts 180 generated as discussed above are visually displayed. An alert 181 corresponding to too many frustrations associated with key activity publish PPO 130h may be displayed as a red dot within the key activities. A second alert 182 disposed in a frustration 150b corresponding to a status change in a project or frustration occurs. As can be seen the alerts 180 may be color coded. In a non limiting example a pink alert may indicate new/backlog; a red alert indicates a top priority alert; a yellow alert indicates that a project is in process to address the alert; a green alert means that a project has been implemented and a black alert means the project is on hold.

The inventive methodology utilizes key processes, key activities, metrics and frustrations, but transforms this use by making use of frustration type and severity. The frustration type and frustration severity are used to analyze the map for performance improvement; opportunities. The opportunities are converted to potential performance improvement projects which are then prioritized and classified as a function of the frustration severity and type and how they are associated with key processes and key activities.

The use of the metrics and frustrations along with other information is used to analyze the map by evaluating and stratifying the metrics and frustrations to identify potential performance improvement opportunities using the analysis of the information contained in the map. This activity creates a descriptive, visual analytic map to enable a user to easily access the current state of a company's operations so that the strength and weaknesses of the observed unit are known. This data produced by the map is then used to identify potential improvement projects. The performance improvement projects are prioritized and tracked to generate real-time reports as well as the ability to display a centralized, intuitive dashboard.

By utilizing frustration type and frustration severity, along with metrics, an improved methodology for monitoring and implementing operational performance improvement for use across a business organization is provided. The methodology improves operational performance improvement and minimizes underperformance so that the value of the organizational unit can be optimized. The methodology is sustainable and scalable to enable growth.

It should be further recognized that the invention is not limited to the particular embodiments described above. Accordingly, numerous modifications can be made without departing from the spirit of the invention and scope of the claims appended hereto.

What is claimed is:

1. A method for monitoring and improving an operation; the operation consisting of one or more key processes, each key process having one or more key activities, by:
identifying at least one frustration associated with at least one key activity of an operation, each frustration having an associated frustration type and an associated frustration severity;
identifying at least one metric associated with at least one key activity;
determining an improvement opportunity as a function of at least two of a number of frustrations associated with a key activity, the severity of any one frustration associated with the at least one key activity, and a number of metrics associated with any of the at least one key activity; and
assigning a project to each improvement opportunity, wherein a priority of projects is determined as a function of a criticality of the project.

2. The method of claim 1, further comprising the steps of determining a number of metrics associated with each key process; identifying an opportunity as a function of the number of metrics associated with a respective key process.

3. The method of claim 1, further comprising the steps of determining a number of metrics associated with each key activity; identifying an opportunity as a function of the number of metrics associated with a respective key activity

4. The method of claim 1, further comprising the steps of determining a number of frustrations associated with each key process; identifying an opportunity as a function of the number of frustrations associated with a respective key process

5. The method of claim 1, further comprising the steps of determining a number of frustrations associated with each key activity; identifying an opportunity as a function of the number of metrics associated with a respective key activity

6. The method of claim 1, further comprising the step of determining a type of frustration of each frustration, determining if a number of any one type of frustration exceeds a predetermined percentage of all frustrations, identifying the type of frustration as corresponding to a critical improvement opportunity when the type of frustration exceeds the predetermined percentage of all frustrations.

7. The method of claim 1, further comprising the step of sorting each frustration by severity of frustration, determining a number of occurrences of each type of severe frustration, and identifying a critical improvement opportunity when the number of any one severe frustration exceeds a predetermined number.

8. The method of claim 1, further comprising the step of displaying a digital map, the digital map graphically displaying each key activity, graphically displaying an association between the at least one frustration and the associated activity, and graphically displaying the association between the metric and the key activity.

9. The method of claim 1, further comprising the step of determining whether the project is a critical potential project, prioritizing the project as a function of a critical potential project status.

10. The method of claim 8, further comprising the steps of updating an image of the project displayed at the digital map as function of priority of the project by determining a project status, updating a status display of the project as a function of one of a change in project status, determining whether a project is complete, and determining a project status when not complete.

11. A digital map, the digital map, the map illustrating an operation; the operation consisting of one or more key processes, each key process having one or more key activities; the digital map comprising: a display opportunities, a display of each key activity, a display of an association between at least one frustration and an associated activity, and a display of the association between a metric and the key activity; each display changing in real time as a function of a change in a status of the frustration; the display of the opportunity changing as a function of a number of metrics associated with each key process. a number of metrics associated with each key activity, or a number of frustrations associated with each key process.
